(19) United States
(12) Patent Application Publication
(10) Pub. No.: US 2025/0299230 A1
(43) Pub. Date: Sep. 25, 2025

(54) PLATFORM AND METHOD FOR AUTOMATICALLY SUBMITTING SUPPLEMENTING DONATION REQUESTS

(71) Applicant: Impact Ventures, LLC, Atlanta, GA (US)

(72) Inventors: Adam Weinger, Atlanta, GA (US); Kanwei Li, Atlanta, GA (US)

(21) Appl. No.: 18/925,820

(22) Filed: Oct. 24, 2024

Related U.S. Application Data
(60) Provisional application No. 63/567,269, filed on Mar. 19, 2024.

(51) Int. Cl. G06Q 30/0279

(52) U.S. Cl. CPC G06Q 30/0279

(57) ABSTRACT

A system and method for automatically submitting supplemental donation requests from a donation platform to a corporate vendor platform. The system receives an indication of an employee donation to a nonprofit organization from an external donation platform. The system determines additional information needed for a corporation to make a supplemental donation and collects this information from the donation form and the nonprofit organization. Based on predefined rules, the system determines the eligibility of the employee donation for a supplemental corporate donation. The system submits a request for the supplemental corporate donation to the corporate vendor platform, including the necessary information and the indication of the employee donation. The system notifies the nonprofit organization of the submitted supplemental corporate donation.

### RELATED APPLICATION

Under provisions of 35 U.S.C. § 119(e), the Applicant claims the benefit of U.S. Provisional Application No. 63/567,269 filed on Mar. 19, 2024, which is incorporated herein by reference.

It is intended that the referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to the field of charitable giving and corporate philanthropy. More specifically, it pertains to systems and methods for automating matching gift programs between donors, nonprofits, and corporations through integration of donation platforms with corporate social responsibility platforms.

### BACKGROUND

In some situations, corporate matching gift programs may be underutilized due to complex submission processes. For example, employees who make charitable donations may need to manually enter donation information into separate corporate vendor platforms to request matching gifts. Thus, the conventional strategy may be to rely on donors to initiate and complete the matching gift request process independently. This often causes problems because the conventional strategy may not provide a streamlined experience for donors. For example, the manual entry of donation details into multiple systems may lead to errors, omissions, or abandonment of the matching gift request process. Additionally, the lack of real-time data transfer between donation platforms and corporate vendor systems may result in delays and inefficiencies. Furthermore, the absence of automated feedback mechanisms may leave donors uncertain about the status of their matching gift requests. These challenges may contribute to reduced participation in corporate matching gift programs, potentially limiting the impact of charitable giving initiatives.

When a corporation wants to offer a supplemental gift program to its employees, the corporation often uses a corporate vendor platform (also known as a Corporate Social Responsibility (CSR) platform, workplace giving solution, etc.) to manage the program. The corporation tells the corporate vendor what they want their supplemental gift program to look like (e.g., what minimum donation amount they will match, what maximum donation amount they will match, a matching percentage, what types of nonprofits they will match to, what specific nonprofits they will match to, and/or the like). The corporate vendor processes matching gift requests through an internal logic, based on the program requirements set by the corporation.

Most often, an employee of a company with a matching gift program will go directly to the website of a non-profit to which the employee wishes to donate to make a gift. Thereafter, the employee must use a process set by the corporate vendor to upload a record of the donation to be matched. This can entail the donor going to a new browser window, navigating to the website of the corporate vendor, logging into an instance of the corporate vendor platform associated with the corporation using their employee credentials, entering their donation information, finding and supplying the EIN number of the nonprofit they donated to, finding and uploading the receipt of their donation, and/or potentially other steps. Because of these extra steps, this process of offline donation matching is infrequently used. These required additional steps after the donation is made on a different platform act as significant barriers to conversion.

This underutilization of workplace giving programs is bad for companies, bad for corporate vendors, bad for nonprofits, and bad for donors. In particular, corporations do not provide as many supplemental donations as they otherwise could, non-profits receive less money than they otherwise would, and donors do not provide as much funding as they could utilizing the donation matching programs.

Thus, there is a need for a donation matching request process that simplifies the matching gift request submission process by eliminating the need for the donor to be redirected or take additional steps.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed below is a process of automatically submitting supplemental (e.g., matching) gift requests from a donation platform to a corporate vendor platform, and a platform for doing the same. The process may bypass a requirement for the donor to log in to a corporate vendor platform to fill out a matching gift request. Additionally or alternatively, the process may reduce or eliminate the need for the donor to enter information that was provided on the donation page.

According to one aspect of the present invention, one or more non-transitory computer readable media comprising instructions which, when executed by one or more hardware processors, causes performance of operations comprising receiving an indication of an employee donation to a nonprofit organization from a donation form of an external donation platform; determining additional information needed for a corporation employing the employee to make a supplemental donation to the nonprofit organization; causing collection of the additional information from one or more of: the donation form and the non-profit organization; determining, based at least in part on one or more rules, the indication of the employee donation, and the collected additional information, that the employee donation is eligible for a supplemental corporate donation; submitting, to a corporate vendor platform associated with the corporation, a request for the supplemental corporate donation, the request comprising at least a portion of the additional information and the indication of the employee donation; and notifying the nonprofit organization of the submitted supplemental corporate donation.

According to another aspect, a computer-implemented method for submitting supplemental corporate donation requests, comprising receiving, via a computer interface, an indication of an employee donation to a nonprofit organization from a donation form of an external donation platform; determining additional information needed for a corporation employing the employee to make a supplemental donation to the nonprofit organization; causing collection of the additional information from one or more of: the electronic donation form and the non-profit organization; determining, based at least in part on one or more rules, the indication of the employee donation, and the collected additional information, that the employee donation is eligible for a supplemental corporate donation; submitting, to a corporate vendor platform associated with the corporation, a request for the supplemental corporate donation, the request comprising at least a portion of the additional information and the indication of the employee donation; and notifying the nonprofit organization of the submitted supplemental corporate donation.

According to yet another aspect, a system comprising at least one device including a hardware processor; the system being configured to perform operations comprising receiving an indication of an employee donation to a nonprofit organization from a donation form of an external donation platform; determining additional information needed for a corporation employing the employee to make a supplemental donation to the nonprofit organization; causing collection of the additional information from one or more of: the donation form and the non-profit organization; determining, based at least in part on one or more rules, the indication of the employee donation, and the collected additional information, that the employee donation is eligible for a supplemental corporate donation; submitting, to a corporate vendor platform associated with the corporation, a request for the supplemental corporate donation, the request comprising at least a portion of the additional information and the indication of the employee donation; and notifying the nonprofit organization of the submitted supplemental corporate donation.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a platform for automatically submitting supplementing donations;

FIG. 3 is a block diagram of a system including a computing device for performing the method of FIG. 2;

FIG. 4 is a sample screenshot of a donation form for incorporating a donation request engine of the present application for automatically submitting a supplementing donation request;

FIG. 5 is a sample screenshot of an external donation platform presenting a donation form incorporating the donation request engine prompting a donor to begin the automatic submission;

FIG. 6A shows a first example interface providing information for use in a first workflow of the platform for automatically submitting supplementing donations;

FIG. 6B shows a second example interface providing information for use in the first workflow of the platform for automatically submitting supplementing donations;

FIG. 7A shows a first example interface providing information for use in a second workflow of the platform for automatically submitting supplementing donations;

FIG. 7B shows a second example interface providing information for use in the second workflow of the platform for automatically submitting supplementing donations;

FIG. 7C shows a third example interface providing information for use in the second workflow of the platform for automatically submitting supplementing donations;

FIG. 7D shows a fourth example interface providing information for use in the second workflow of the platform for automatically submitting supplementing donations;

FIG. 8A shows a first example interface providing information for use in a third workflow of the platform for automatically submitting supplementing donations;

FIG. 8B shows a second example interface providing information for use in the third workflow of the platform for automatically submitting supplementing donations;

FIG. 8C shows a third example interface providing information for use in the third workflow of the platform for automatically submitting supplementing donations;

FIG. 8D shows a fourth example interface providing information for use in the third workflow of the platform for automatically submitting supplementing donations;

FIG. 8E shows a fifth example interface providing information for use in the third workflow of the platform for automatically submitting supplementing donations;

FIG. 8F shows a sixth example interface providing information for use in the third workflow of the platform for automatically submitting supplementing donations;

FIG. 9A shows a first example interface providing information for use in a fourth workflow of the platform for automatically submitting supplementing donations; and

FIG. 9B shows a second example interface providing information for use in the fourth workflow of the platform for automatically submitting supplementing donations.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, ¶16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of providing donation requests to match employee donations to one or more nonprofit organizations, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

In some situations, corporate matching gift programs may be underutilized due to complex submission processes. For example, employees who make charitable donations may need to manually enter donation information into separate corporate vendor platforms to request matching gifts. Thus, the conventional strategy may be to rely on donors to initiate and complete the matching gift request process independently. This often causes problems because the conventional strategy may not provide a streamlined experience for donors. For example, the manual entry of donation details into multiple systems may lead to errors, omissions, or abandonment of the matching gift request process. Additionally, the lack of real-time data transfer between donation platforms and corporate vendor systems may result in delays and inefficiencies. Furthermore, the absence of automated feedback mechanisms may leave donors uncertain about the status of their matching gift requests. These challenges may contribute to reduced participation in corporate matching gift programs, potentially limiting the impact of charitable giving initiatives.

When a corporation wants to offer a supplemental gift program to the employees, the corporation often uses a corporate vendor platform (also known as a Corporate Social Responsibility (CSR) platform, workplace giving solution, etc.) to manage the program. The corporation tells the corporate vendor what they want their supplemental gift program to look like (e.g., what minimum donation amount they will match, what maximum donation amount they will match, a matching percentage, what types of nonprofits they will match to, what specific nonprofits they will match to, and/or the like). The corporate vendor processes matching gift requests through an internal logic, based on the program requirements set by the corporation.

Most often, an employee of a company with a matching gift program will go directly to the website of a non-profit to which the employee wishes to donate to make a gift. Thereafter, the employee uses a process set by the corporate vendor to upload a record of the donation to be matched. This can entail the donor going to a new browser window, navigating to the website of the corporate vendor, logging into an instance of the corporate vendor platform associated with the corporation using their employee credentials, entering their donation information, finding and supplying the EIN number of the nonprofit they donated to, finding and uploading the receipt of their donation, and/or potentially other steps. Because of these extra steps, this process of offline donation matching is infrequently used. These required additional steps after the donation is made on a different platform act as significant barriers to conversion.

This underutilization of workplace giving programs is bad for companies, bad for corporate vendors, bad for nonprofits, and bad for donors. In particular, corporations do not provide as many donations as they otherwise could, non-profits receive less money than they otherwise would, and donors do not provide as much funding as they could utilizing the donation matching programs.

Disclosed below is a platform and process for automatically submitting supplemental (e.g., matching) gift requests from a donation platform to a corporate vendor platform, and a platform for doing the same. The process may bypass a requirement for the donor to log in to a corporate vendor platform to fill out a matching gift request. Additionally or alternatively, the process may reduce or eliminate the need for the donor to enter information that was provided on the donation page.

A platform may be provided for automating the matching gift submission process. The platform may include a matching gift plugin integrated within an external donation platform. When a donor makes a contribution through the external donation platform, the matching gift plugin may determine if the donor is eligible for a matching gift from their employer. If eligible, the plugin may collect the necessary information from the donation form, the donor, and/or the non-profit associated with the donation to automatically populate and submit a matching gift request.

An external donation platform may receive an application or plugin for execution on the external donation platform. The application may allow for collection of data from a donation made by a donor submitted using an online donation form. The donation form may collect information input by the donor (e.g., donation amount, employer information, authorization to submit for matching) as well as information associated with the non-profit that operations the external donation platform (e.g., non-profit name, EIN number, etc.). In embodiment, the application or plugin may be integrated into the donation form. In some embodiments, the application may be visible to the employee as they fill out the donation form and/or after successfully completing the donation form. The application or plugin may be received directly from a corporate vendor. Alternatively, the application or plugin may be received from a third party vendor to facilitate connection to one or more corporate vendors.

Thereafter, responsive to a donor entering information in a donation form, the external donation platform or plugin may transmit, to the corporate vendor platform, an indication of the employee donation, including at least the donation amount, an identification of the nonprofit, and an identification of the employer of the donor. The corporate vendor platform may determine whether the employee donation qualifies for a matching corporate donation. This determination may be made based on one or more rules put in place by the corporation, and may be at the corporate vendor platform.

Responsive to a determination that the employee donation is eligible for a matching corporate donation, the corporate vendor platform may send a donation to the non-profit associated with the employee donation on behalf of the corporation.

In some embodiments, the platform may optionally include a feedback loop providing data from the corporate vendor to the nonprofit. In embodiments, the data may be provided by a third party facilitator and/or through any other means of conveying data to the corporate vendor platform. The feedback data may include, for example, information indicating approval or rejection of the request for a supplemental donation, a status of disbursement of the supplemental donation from the corporation, and/or any other information of interest to the nonprofit.

The platform enables the automatic submission of supplemental donation requests by integrating donation platforms with corporate vendor platforms. This integration allows for the seamless transfer of donation data, eliminating the need for manual entry by the donor. By automating the submission process, the platform reduces the likelihood of errors and omissions that can occur with manual data entry, thereby increasing the accuracy and efficiency of the matching gift process. The platform also reduced the steps required by employees to cause their employers to submit supplemental donations in accordance with the employer guidelines, increasing charitable giving.

The platform may be configured to perform operations such as receiving an indication of an employee donation, determining additional information needed, and submitting a request for a supplemental corporate donation ensures that the donation data is processed in real-time. This real-time processing capability enhances the responsiveness of the platform, providing immediate feedback to both the nonprofit organization and the donor regarding the status of the matching gift request.

By notifying the nonprofit organization of the submitted supplemental corporate donation, the platform creates a feedback loop that keeps all parties informed. This transparency improves the overall user experience for donors and nonprofits, as they are kept up-to-date on the progress and approval of matching gifts. Additionally, the ability of the platform to store data associated with the submitted matching donation ensures that all relevant information is archived for future reference, aiding in record-keeping and compliance.

The platform may be capable of determining eligibility based on predefined rules, such as (but not limited to) minimum and maximum donation amounts, employee eligibility criteria, and/or donation match ratios, ensuring that only valid matching gift requests are processed. This rule-based validation reduces the administrative burden on corporate vendors and nonprofits, allowing them to focus on more strategic activities rather than manual verification of donation eligibility.

Overall, the platform provides a streamlined, efficient, and accurate method for facilitating the submission of external matching gift requests, thereby increasing participation rates and maximizing the impact of corporate philanthropy initiatives.

Embodiments of the present disclosure may comprise methods, systems, and a computer readable medium comprising, but not limited to, at least one of the following:
A. An External Donation Platform;
B. A Supplemental Donation Request Engine;
C. A Program Vendor Platform;
D. A Corporate Platform; and
E. A User Platform.

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components as found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
receiving a list of one or more rules for providing a corporate donation in response to a donation from an employee of a corporation;
receiving an indication of an employee donation from an external donation platform;
determining, based at least in part on the list of one or more rules and the indication of the employee donation, that the employee donation is eligible for a matching corporate donation;
submitting the matching corporate donation to a non-profit organization associated with the external donation platform; and
optionally notifying the nonprofit of the submitted matching donation request and subsequent action taken by the company to approve, deny, or disburse funds in response to the request.

Although the aforementioned method has been described to be performed by the platform 100, it should be understood that computing device 300 may be used to perform the various stages of the method. Furthermore, in some embodiments, different operations may be performed by different networked elements in operative communication with computing device 300. For example, a plurality of computing devices may be employed in the performance of some or all of the stages in the aforementioned method. Moreover, a plurality of computing devices may be configured much like a single computing device 300. Similarly, an apparatus may be employed in the performance of some or all stages in the method. The apparatus may also be configured much like computing device 300.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

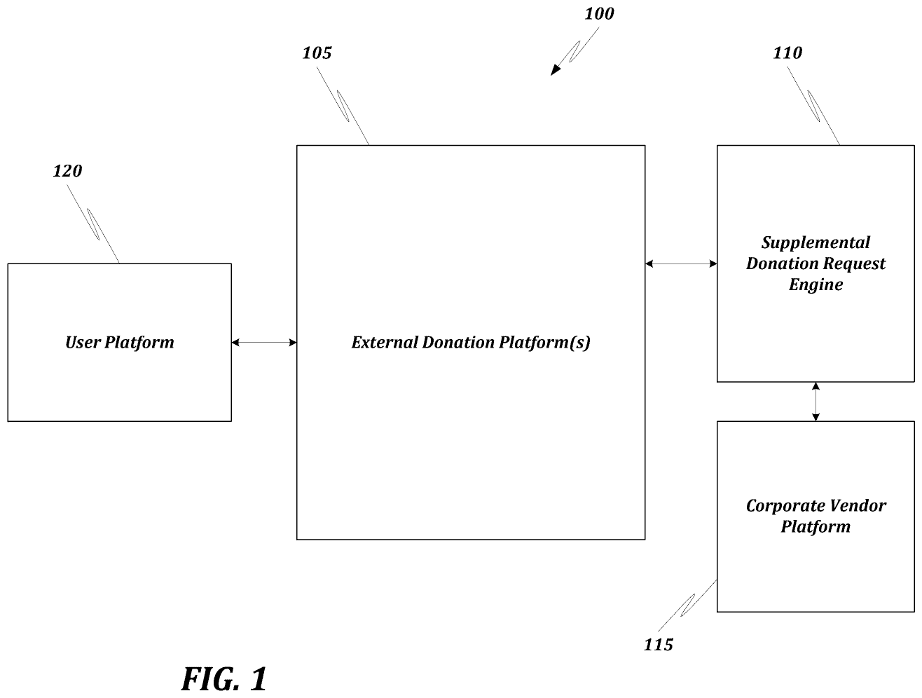

FIG. 1 illustrates one possible operating environment through which a platform consistent with embodiments of the present disclosure may be provided. By way of non-limiting example, an automatic supplemental donation platform 100 may be hosted on, for example, a cloud computing service. In some embodiments, the platform 100 may be hosted on a computing device 300. A user (e.g., a corporate employee) may access platform 100 through a software application and/or hardware device. The software application may be embodied as, for example, but not be limited to, a website, a web application, a desktop application, and a mobile application compatible with the computing device 300. One possible embodiment of the software application and/or hardware device may be provided by the 360MatchPro suite of products and services provided by Impact Ventures, LLC doing business as Double the Donation.

The platform 100 may include, for example, one or more external donation platforms 105, a donation supplemental donation request engine 110, a corporate vendor platform 115 associated with a corporate vendor and a user platform 120 associated with one or more employees of the corporation. Accordingly, embodiments of the present disclosure provide a software and hardware platform comprised of a distributed set of computing elements, including, but not limited to:

### A. An External Donation Platform

As shown in FIG. 1, the platform 100 may include one or more external donation platforms 105. The one or more external donation platforms 105 may include hardware and/or software configured to receive one or more donations for one or more nonprofit organizations. As a non-limiting example, at least one (e.g., each) of the one or more external donation platforms may include hardware and/pr software configured to provide a donation interface for allowing a user (e.g., a corporate employee) to enter donation information.

The donation interface may be configured to display a donation form which may allow a donor (e.g., a corporate employee) to enter donation information, including (but not limited to) a donation amount, payment information, an employer identifier (e.g., a corporation name, an identifier number, etc.), an indication of consent to allow the external donation platform to submit a supplemental donation request, and/or any other information needed to complete the donation from the donor. The donation form may be accessible to donors via a web interface. The external donation platform 105 may process the initial gift, which may be a requirement for a matching gift to be made.

The donation form on the external platform 105 may be integrated with a matching gift plugin or software. This integration may allow the matching gift software to collect some of the data necessary to populate a matching gift request submission. The donation form may include fields for the donor to enter their employer information or search for their company name.

Upon submission of a donation through the external platform, the external platform 105 may generate a confirmation page or screen. This confirmation page may display details of the completed donation and may provide an opportunity for the donor to initiate a matching gift request if eligible (e.g., via the supplemental donation request engine 110). The confirmation page may incorporate functionality from the integrated matching gift software to facilitate this process.

The external donation platform may transmit donation data in real-time to the supplemental donation request engine 110 via an API or other integration method. This data transmission may include details such as the donation amount, donor information, and any company matching information provided by the donor during the donation process.

The external platform 105 may support various payment methods and may securely process financial transactions. It may generate receipts or acknowledgments for donors, which may be used as documentation for matching gift requests and/or for tax purposes. The external donation platform 105 may store donation records and provide reporting capabilities for nonprofit organizations using the platform.

In embodiments, one or more (e.g., each) of the external donation platforms 105 is external to (e.g., operated and/or controlled by) an entity outside of the corporation and/or the corporate vendor.

### B. A Supplemental Donation Request Engine

As shown in FIG. 1, the platform 100 may include a supplemental donation request engine 110. The supplemental donation request engine 110 may include hardware and/or software configured to receive data from the external donation platform, determine a corporate vendor associated with an employer of an employee donor, and request a supplemental donation on behalf of the employee donor. In embodiments, the supplemental donation request engine 110 may be integrated into one or more (e.g., each) of the external donation platforms. For example, one or more Application Program Interfaces (APIs) may connect an external donation platform 105 and the supplemental donation request engine 110. The supplemental donation request engine 110 may receive, from the external donation platform 105, donation information associated with at least one donation. The engine 110 may determine whether the donation included consent to submit the donation to a corporation for supplemental donation (e.g., donation matching).

Responsive to a determination that the donation included the consent, the supplemental donation request engine 110 may receive an indication of an employee donation to a nonprofit organization from a donation form of an external donation platform. The indication may include information such as the donation amount and nonprofit organization details. The engine 110 may compare the received donation information to a list of one or more corporate partners to determine if the donor is an employee of a corporation that works with one or more corporate vendors. For example, the engine may include logic to compare the donation to a list of one or more corporations working with a corporate vendor to provide supplemental donations to the non-profit.

In some embodiments, upon receiving the donation indication, the supplemental donation request engine 110 may determine additional information needed for the corporation employing the employee to make a supplemental donation to the nonprofit organization. This additional information may include employee verification details or other data required by the corporation's matching gift program rules. The supplemental donation request engine 110 may cause collection of the additional information from one or more sources. The additional information may be collected from the donation form itself, if available. Alternatively or additionally, the engine 110 may collect information directly from the nonprofit organization.

Based on one or more rules, the donation indication, and the collected additional information, the supplemental donation request engine 110 may determine whether the employee donation is eligible for a supplemental corporate donation. The rules may specify criteria such as minimum or maximum donation amounts, employee eligibility requirements, or matching ratios.

Responsive to a determination that the donor is associated with a corporation on the list, the engine 110 may provide the corporate vendor (e.g., via the corporate vendor platform 115) a request for supplemental donation, together with information associated with the donation (e.g., nonprofit name, EIN, donation amount, etc.) and/or information associated with the employee donor (e.g., name, employer ID, work email address, etc.). In embodiments, the information may be collected from data entered by the employee donor into the donation form and/or from the third party donation platform.

In some embodiments, the supplemental donation request engine 110 may receive feedback data related to fulfillment of one or more requested supplemental donations. For example, the feedback data may include, but need not be limited to, information indicating approval or rejection of the request for a supplemental donation, a status of disbursement of the supplemental donation from the corporation, and/or any other information of interest to the nonprofit. The supplemental donation request platform may provide this feedback to the nonprofit.

After submitting the request, the supplemental donation request engine 110 may notify the nonprofit organization of the submitted supplemental corporate donation request. This notification may allow the nonprofit to track potential incoming matching funds. The supplemental donation request engine 110 may interface with multiple external systems. The integration may allow the supplemental donation request engine 110 to interface with various donation platforms used by nonprofits to collect initial donation data. The engine 110 may integrate with multiple corporate vendor platforms to submit matching gift requests across different corporations.

### C. A Corporate Vendor Platform

As shown in FIG. 1, the platform 100 may include a corporate vendor platform 115. The corporate vendor platform 115 may include hardware and/or software configured to receive donation information associated with one or more corporate partners. Responsive to receiving an indication of a donation, the corporate vendor platform may transmit, to the corporation associated with the donation, at least a portion of the donation information as a donation request.

In some embodiments, the corporate vendor platform 115 may include hardware and/or software configured to obtain authorization of a supplemental donation from the corporation. In some embodiments, obtaining the approval from the corporation may require an explicit approval received from the corporation in response to the donation indication. The corporate vendor platform 115 may receive, from the corporation, a donation approval and may provide supplemental donation funds to the non-profit based on the received donation approval from the corporation. Alternatively, the approval may be preauthorized by the corporation prior to transmission of any specific donation indication (e.g., all donations from employees may be preauthorized, all donations up to a certain dollar amount may be preauthorized, etc.).

In embodiments, the corporate vendor platform 115 may include hardware and/or software configured to inform the corporation of one or more donations made on behalf of the corporation. For example a corporate donation notification may be transmitted to the corporation. The corporate donation notification may include, for example, a donation amount, an identifier of the nonprofit organization to which the funds were donated, an identifier of the employee donation that triggered the corporate donation, an identifier of the employee that made the employee donation, and/or any information useful to the corporation.

In some embodiments, the corporate vendor platform 115 may include hardware and/or software configured to establish one or more rules for approving supplemental (e.g., matching) donations. The one or more rules may include, for example, a lower limit dollar amount, an upper limit dollar amount, a matching percentage, an identification of one or more nonprofit organizations approved to be matched, an indication of whether a donation requires specific approval, and/or any other rule useful for approving or denying matching corporate donations. In embodiments, at least a portion of the one or more rules may be transmitted to the corporate vendor platform 115 by the corporation represented by the corporate vendor.

In some embodiments, the corporate vendor platform 115 may receive one or more donation notifications. Based on the one or more donation notifications and the one or more rules, the corporate vendor platform 115 may approve or deny a corporate matching donation associated with the donation notification.

In some embodiments, the corporate vendor platform 115 may transmit the approval or denial of one or more (e.g., each) corporate matching donation to the corresponding external donation platform. In some embodiments, the corporate vendor platform 115 may transmit the approval or denial directly to the corresponding external donation platform. Additionally or alternatively, the corporate vendor platform may transmit the approval or denial to a third party platform (e.g., via the supplemental donation request engine 110). In some embodiments, the third party platform may transmit a notification regarding the approval or denial to the corresponding external donation platform.

In some embodiments, if the request for supplemental donation is approved, the corporate vendor platform 115 may initiate disbursement of the supplemental corporate donation to the nonprofit organization. The corporate vendor platform 115 may notify the automatic supplemental donation platform 100 of the approval and/or the disbursement.

In embodiments, the corporate vendor platform 115 may record information related to one or more processed requests for supplemental donation and/or one or more corporate matching donations made on behalf of the corporation. For example, the corporate matching donation information may be recorded in a data store, published to a website, and/or the like. The information may include the donation amount, employee information, nonprofit organization information, approval status, and/or disbursement details. This data may be used for reporting and analytics purposes.

The corporate vendor platform 115 may provide an interface for administrators at the corporation to review and manage matching gift requests. The interface may allow administrators to view pending requests, approve or deny requests, and/or generate reports on matching gift activity.

The corporate vendor platform 115 may integrate with corporate payroll or HR systems to verify employee eligibility for matching gifts. The platform 115 may integrate with corporate finance systems to facilitate disbursement of approved matching donations.

### D. A User Platform

As shown in FIG. 1, the platform 100 may include one or more user platforms 120. Each of the one or more user platforms 120 may include hardware and/or software configured to allow an associated user to access the platform 100 by connecting to at least one of the one or more external donation platforms 105. In embodiments, the user platform 120 may be configured to display the donation page from the external donation platform 105 including the integrated supplemental donation request engine 110, and to provide information to the donation platform 105.

The user platform 120 may connect to at least one of the one or more external donation platforms 105. In some embodiments, the user platform 120 may be configured to display the donation page from the external donation platform 105. The donation page may include the integrated supplemental donation request engine 110. The user platform 120 may be configured to provide information to the donation platform 105.

In some embodiments, the user platform 120 may include a web browser or mobile application for accessing the external donation platform 105. The web browser or mobile application may render the donation form and integrated matching gift functionality provided by the supplemental donation request engine 110.

The user platform 120 may include input devices such as a keyboard, mouse, touchscreen or other means for the user to enter donation information and interact with the matching gift interface. The user platform 120 may also include a display device for presenting the donation form, matching gift eligibility information, and auto-submission authorization interface to the user.

In some implementations, the user platform 120 may store cookies or other local data related to the user's donation and matching gift activities. This may allow for a more streamlined experience if the user returns to make additional donations in the future.

The user platform 120 may transmit donation details, employer information, and auto-submission authorization to the external donation platform 105 and supplemental donation request engine 110 via secure network connections. The platform may utilize encryption and other security measures to protect sensitive user data during transmission.

The user platform 120 may be implemented on various types of computing devices, including desktop computers, laptops, tablets, smartphones, or other internet-connected devices capable of accessing web-based donation forms. The specific hardware and software configuration may vary based on the device type while still enabling the core donation and matching gift functionality.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 300 may be employed in the performance of some or all of the stages disclosed with regard to the methods. Similarly, an apparatus may be employed in the performance of some or all of the stages of the methods. As such, the apparatus may comprise at least those architectural components found in computing device 300.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the method without altering or departing from the fundamental scope of the depicted methods and systems disclosed herein.

### Master Method

Consistent with embodiments of the present disclosure, a method may be performed by at least one of the aforementioned modules. The method may be embodied as, for example, but not limited to, computer instructions, which, when executed, perform the method. The method may comprise the following stages:

An external donation platform may receive a supplemental donation request application or plugin for execution on the external donation platform. The application may allow for collection of data from a donation made by a donor. The donation form may collect information input by the donor (e.g., donation amount, employer information, authorization to submit for matching) as well as information associated with the non-profit that operations the external donation platform (e.g., non-profit name, EIN number, etc.).

Thereafter, responsive to a donor entering information in a donation form, the corporate vendor platform may receive, from one or more of the external donation platform or the application, an indication of the employee donation, including at least the donation amount, an identification of the nonprofit, and an identification of the employer of the donor. The corporate vendor platform may determine whether the employee donation qualifies for a matching corporate donation. This determination may be made based on one or more rules put in place by the corporation and may be made either at the corporate vendor platform or at the corporate platform.

Responsive to a determination that the employee donation is eligible for a matching corporate donation, the corporate vendor platform may send a donation to the non-profit associated with the employee donation on behalf of the corporation.

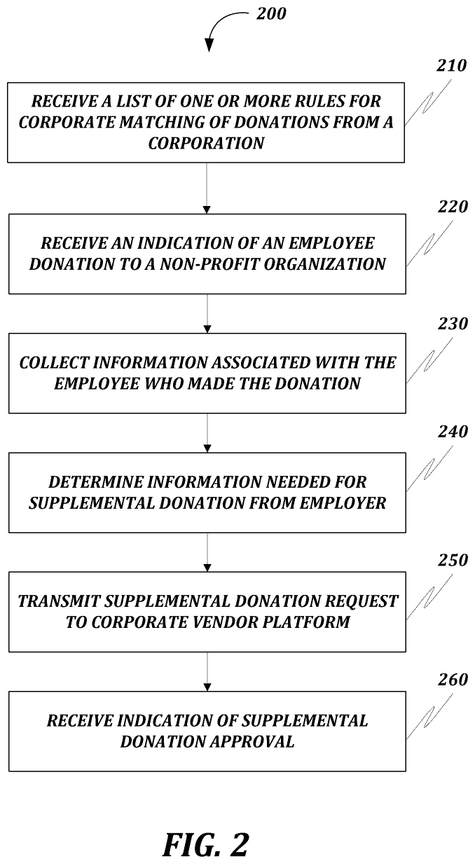

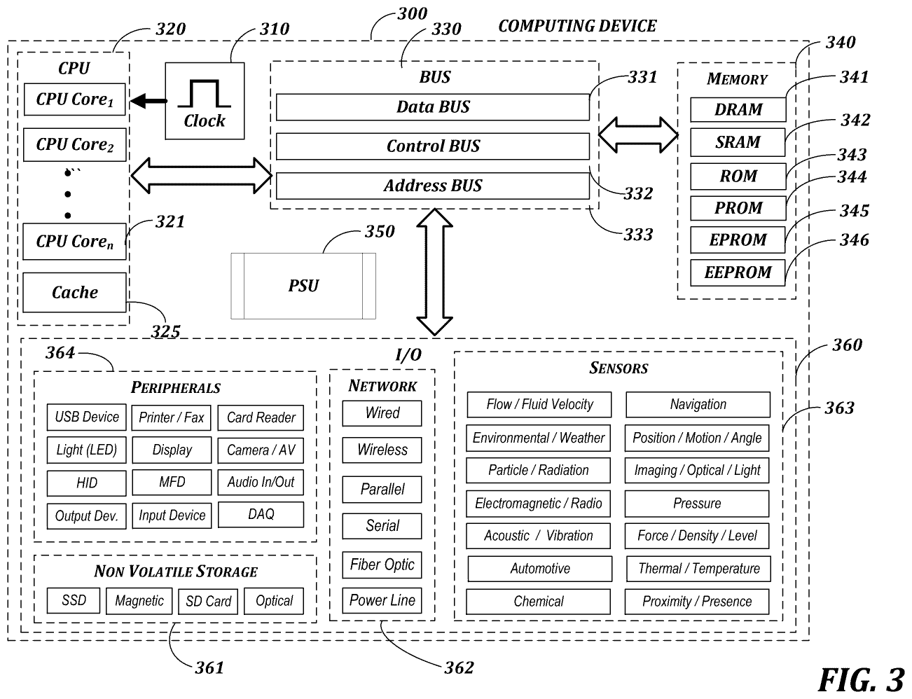

FIG. 2 is a flow chart setting forth the general stages involved in a method 200 consistent with an embodiment of the disclosure for providing and/or operating the automatic supplemental donation platform 100. Method 200 may be implemented using a computing device 300 or any other component associated with platform 100 as described in more detail below with respect to FIG. 3. For illustrative purposes alone, computing device 300 is described as one potential actor in the following stages.

Method 200 may begin at stage 210 where computing device 300 may receive a list of one or more rules for providing a corporate donation in response to a donation from an employee of a corporation. For example, the list of one or more rules may be received at the corporate vendor platform from the corporation (e.g., via the corporate platform). In embodiment, the one or more rules may include, as non-limiting examples, a lower limit to the dollar amount the will be matched by the corporation, an upper limit to the dollar amount that will be matched by the corporation, an upper limit to the number of donations to be matched by a single employee, restrictions on the type of organization to which donations may be matched (e.g., non-political organizations, organizations without a religious affiliation, etc.), restrictions on the actual organizations to which donations will be matched (e.g., a white list of allowed organizations and/or a blacklist of disallowed organizations), and/or any other rules that the organization may wish to impose on corporate giving.

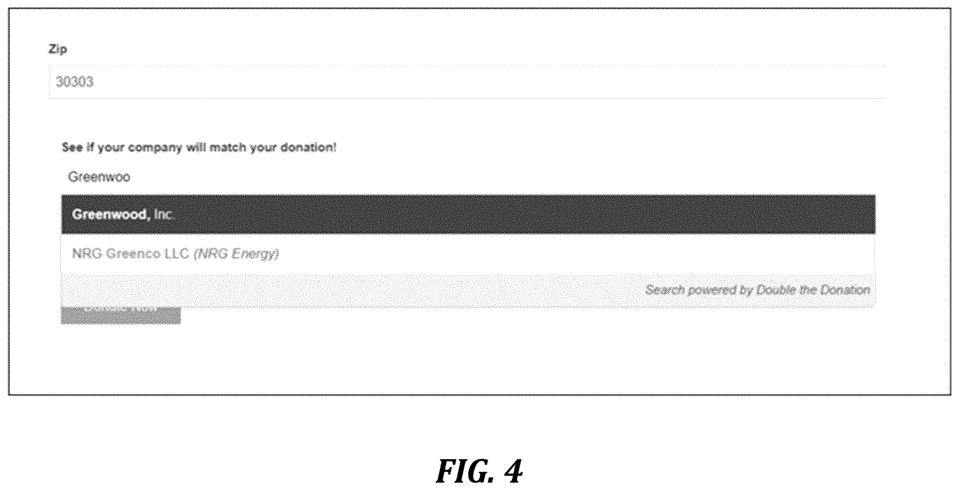

From stage 210, where computing device 300 receives the list of one or more rules, method 200 may advance to stage 220 where computing device 300 may receive an indication of an employee donation from an external donation platform. For example, the external platform may be connected to an API of the corporate vendor platform. When a donation is made, the API may provide an indication of the donation to an employer associated with the donation. As a particular example, a donation form from the external donation platform may include a field to collect information associated with an employer of the donor, as shown in FIG. 4. If the employer of the donor participates in the automatic donation matching program, the external donation platform may invoke the API to transmit an employee donation indication to the corporate vendor platform.

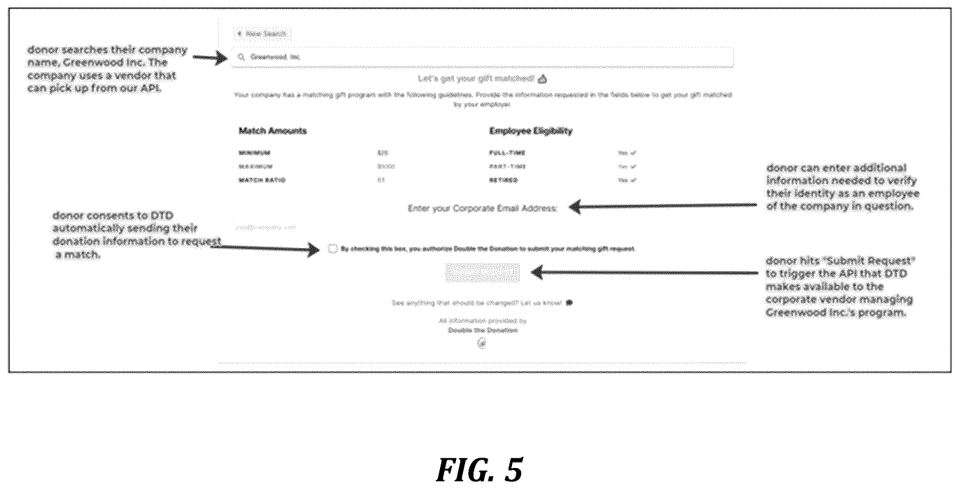

FIG. 5 shows an example interface of an external donation platform that includes an external application (e.g., embodying or including the supplemental donation request engine) thereon. As shown in FIG. 5, the external donation platform may display the stage at which a donor can trigger automatic submission of the supplemental donation request (e.g., following successful donation on the part of the donor). As shown in FIG. 5, after the donor selects their employer, the application (e.g., operating as an API or other supplemental donation request engine) may cause the donation form to display information related to at least a portion of the one or more rules for corporate matching donations. As a non-limiting example, FIG. 5 shows match amount (e.g., minimum donation for match, maximum donation for match, and matching ratio) and eligibility rules, though more, less, or different information may be displayed. In this way, the application may cause the donation form to request additional information from the donor. For example, FIG. 5 shows that the donation form may request a corporate email address to (further) verify employee status, however more and/or different information may be requested. The donation form may optionally include an indication that the donor is submitting the employee donation for a matching corporate donation from the employer and an authorization to do so automatically.

In embodiments, the employee donation indication may be transmitted to a third party platform for processing. The donation indication may include, for example, information associated with the dollar amount of the donation, an identifier of the employer of the donor, an identifier of the non-profit to which the donor gifted money, and/or any other information associated with the donation which may be useful or necessary in determining whether and/or to what extent the donation should be matched.

In stage 230, the third-party platform may determine at least a subset of the information received in the employee donation indication that is needed for submission of a supplemental (matching) corporate donation request. The subset may be determined based at least in part on the employer identifier and a list of rules provided by the employer in stage 210. The employee donation indication may include information input by the employee as part of the donation process and/or information related to the non-profit to which the employee donated.

In stage 240, the third-party platform may transmit to a corporate vendor associated with the employer a supplemental corporate donation request including the subset of the information contained in the employee donation indication. In embodiments, the request may be transmitted via an API, an email, and/or any other electronic means of transmission.

If the corporate vendor platform determines that the employee donation is eligible for a corporate supplemental donation, the method 200 may continue to stage 250, where the corporate vendor platform may submit a matching corporate donation to a non-profit organization associated with the external donation platform. In some embodiments, the computing device may transmit a notification of the approval of the supplemental (e.g., matching) donation. For example, the approval notification may be transmitted directly from the corporate vendor to the third party platform or may be transmitted from the corporate vendor to the application and then forwarded to the third-party donation platform via the application. The third-party platform may receive the approval at stage 250.

In some embodiments, the computing device may optionally transmit a notification of the disbursement of the supplemental (e.g., matching) donation. For example, the disbursement notification may be transmitted directly from the corporate vendor to the third party platform or may be transmitted from the corporate vendor to the application and then forwarded to the donation platform via the application. For example, the computing device may transmit, to the third-party platform, an indication that the donation has been disbursed to the non-profit.

In some embodiments, the third-party platform may optionally record the corporate supplemental (e.g., matching) donation. For example, the third-party platform may store a record of at least the corporate supplemental donation in an electronic data store. In some embodiments, the record may include a receipt from the nonprofit organization (e.g., generated by the external donation platform), which may be sent to the third-party platform (e.g., for forwarding to the corporate vendor platform and/or the corporation), or may be sent to the corporate vendor (e.g., via the corporate vendor platform) which then forwards the receipt to the corporation and the third-party platform.

Once the third-party platform receives the approval of the supplemental donation in stage 250, method 200 may then end at stage 260.

### IV. Example Embodiments

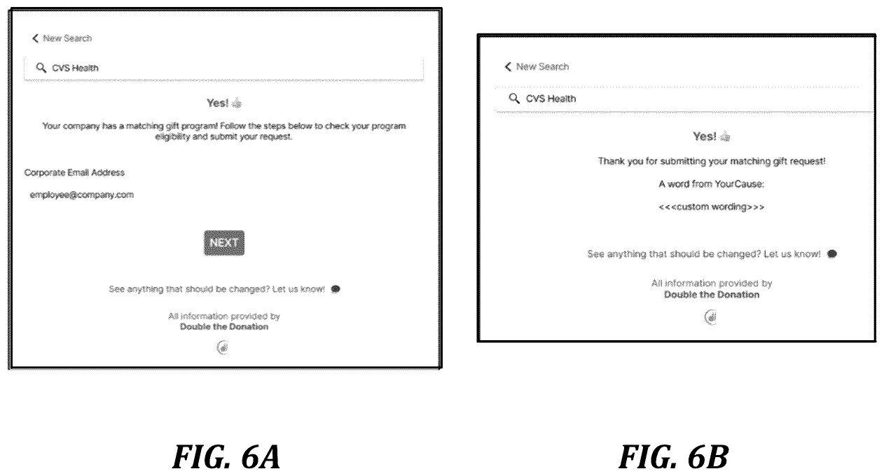

FIGS. 6A and 6B show an example interface for a first scenario making use of the auto-submission process of a matching gift request. This scenario illustrates a use case where an employee of a company begins the auto-submission process. The company only has one matching gift program, and there are no additional questions the employee is required to answer before submitting their matching gift request. The interface guides the donor through a streamlined process, ensuring a smooth and efficient submission of the matching gift request.

As shown in FIG. 6A, the donor enters their corporate email to verify identity. This step involves the donor, who is an employee, entering their corporate email address into the provided field to verify their identity. The interface displays a search bar where the donor can search for their company (in this example, “CVS Health”) via a text input field, drop-down list, or other input method. The interface confirms the presence of a matching gift program with a message, “Yes! Your company has a matching gift program! Follow the steps below to check your program eligibility and submit your request.” The interface further includes a prompt for the user to enter their corporate email address. Upon entering the corporate email address (employee@company.com), the donor clicks the “NEXT” button to proceed.

As shown in FIG. 6B, following submission of the user's email address, the successful submission of the matching gift request is confirmed. The interface displays a message, “Yes! Thank you for submitting your matching gift request!” In some embodiments, the confirmation may be followed by a customizable message from the corporate vendor platform.

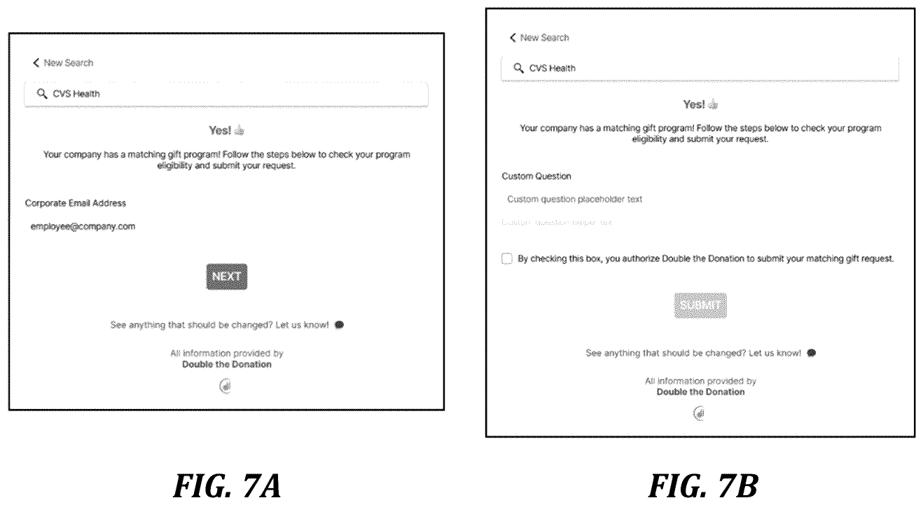

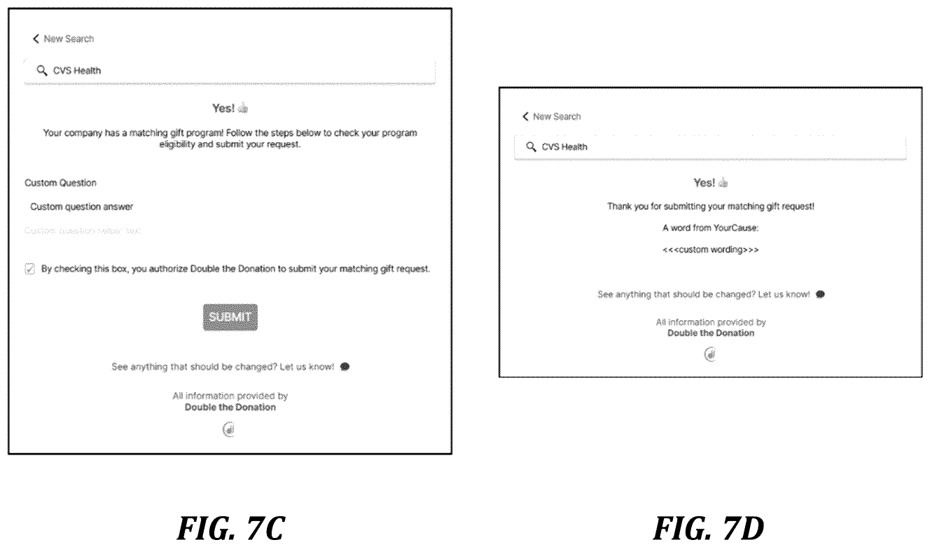

FIGS. 7A-7D show an example interfaces for another process flow involved in the auto-submission of a matching gift request. This figure illustrates a scenario where an employee of a company begins the auto-submission process. The company has one matching gift program but requires an additional question to be answered that may determine other elements of the submission. Examples include (but need not be limited to) choosing from available funds, sharing additional information about the employee, sharing additional information about the organization or campaign, and/or any other question the company may require.

As shown in FIG, 7A, the donor enters their corporate email to verify identity. The interface displays a search bar where the donor can search for their company, in this case, “CVS Health.” The donor is prompted to enter their corporate email address in the provided field. Upon entering the corporate email address (employee@company.com), the donor clicks the “NEXT” button to proceed.

FIG. 7B shows a second step, in which the interface displays a custom question. While FIG. 7B shows a single custom question, additional custom questions may be included without departing from the scope of the invention. The donor is required to respond to the custom question before proceeding. While the interface of FIG. 7B shows a text box to collect a response, additional interface options, such as radio buttons, check boxes, etc. may be used to receive an answer input by the user. The interface confirms the presence of a matching gift program with a message, “Yes! Your company has a matching gift program! Follow the steps below to check your program eligibility and submit your request.”

As shown in FIG. 7C, after the donor inputs an answer, they can submit their request. The interface displays the custom question and a field for the donor to input their response. In some embodiments, the donor is also required to check a box authorizing submission of the matching gift request. Once the donor has provided the necessary information and checked the authorization box, they click the “SUBMIT” button to proceed.

FIG. 7D shows confirmation of the successful submission of the matching gift request. The interface displays a message, “Yes! Thank you for submitting your matching gift request!” This confirmation may be followed by a customizable message from the corporate vendor platform.

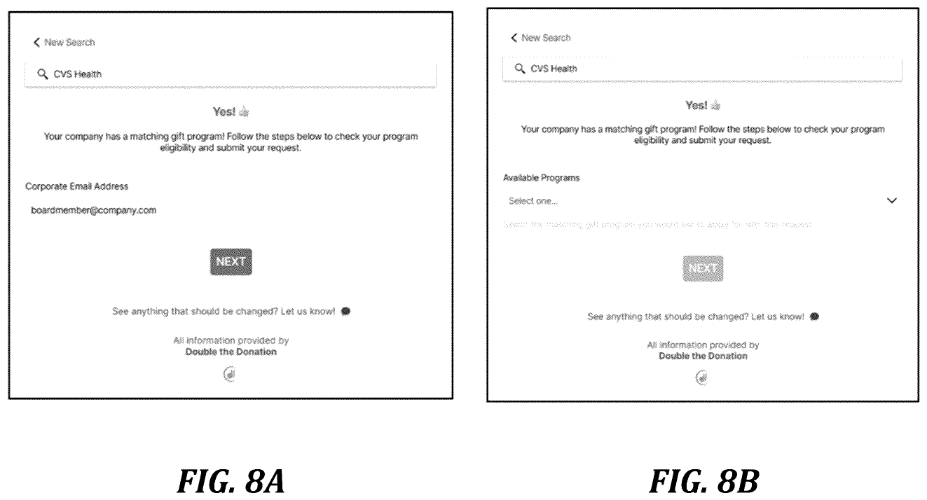

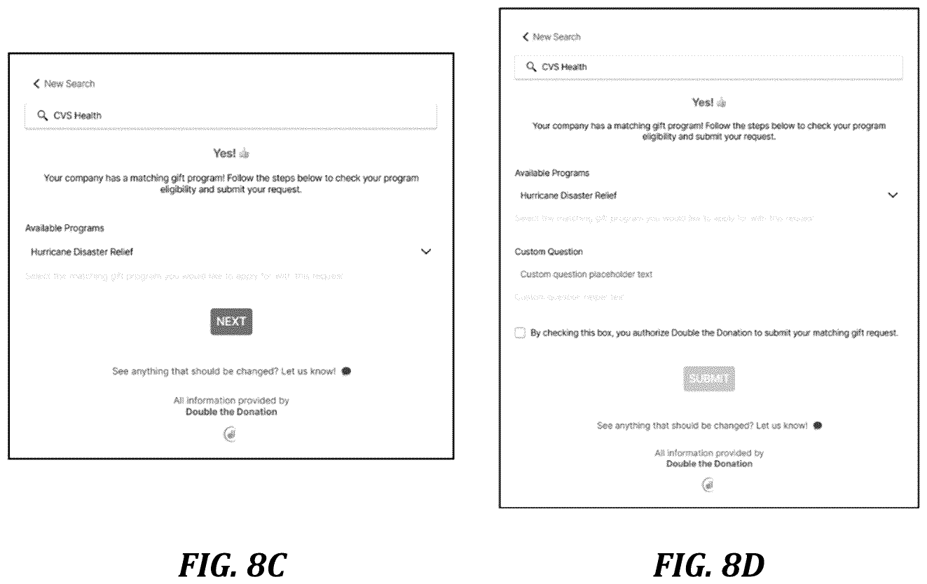

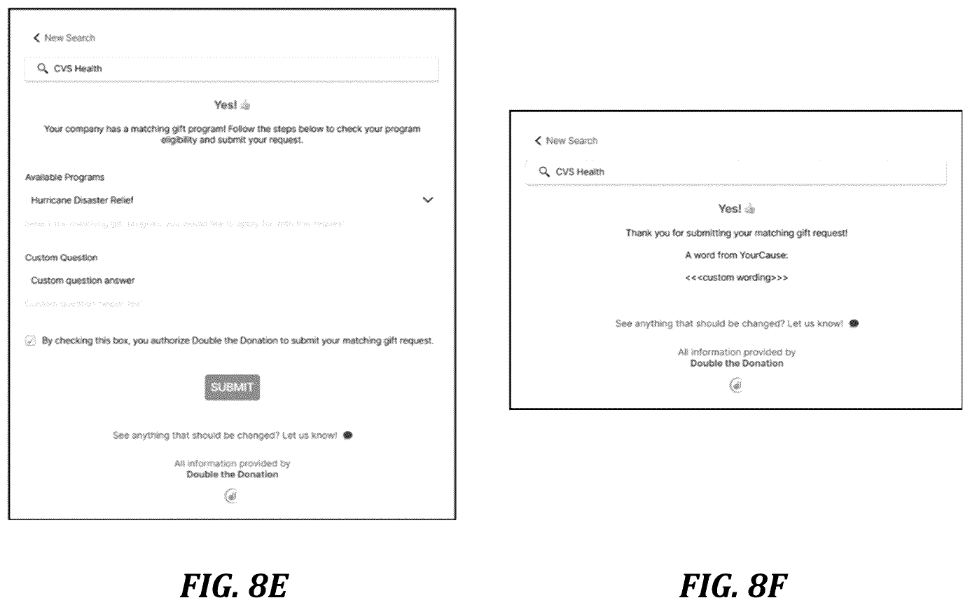

FIGS. 8A-8F show example interfaces for a process flow involved in the auto-submission of a matching gift request. This figure illustrates a scenario where an employee of a company begins the auto-submission process. The company has multiple matching gift programs available. For example, the company may be running multiple campaigns that would allow for donation matching for any employee, and/or the particular employee may be eligible to participate in multiple matching programs. The donor may be prompted to select the program of their choice.

As shown in FIG. 8A, the donor enters their corporate email to verify identity. The interface displays a search bar where the donor can search for their company, in this case, “CVS Health.” The donor is prompted to enter their corporate email address in the provided field. Upon entering the corporate email address (boardmember@company.com), the donor clicks the “NEXT” button to proceed.

As shown in FIG. 8B, multiple donation matching programs are available to the donor. The interface confirms the presence of a matching gift program with a message, “Yes! Your company has a matching gift program! Follow the steps below to check your program eligibility and submit your request.” The donor is prompted to select the program of their choice. The interface displays a list of available programs (e.g., via the dropdown menu labeled “Available Programs” in FIG. 8B) where the donor can select the matching gift program they would like to apply for with this request. The donor selects a program. For example, FIG. 8B shows that the program may be selected via the dropdown menu. In other embodiments, the program may be selected via a radio button selection, a text entry field, and/or via any other method of identifying a program.

As shown in FIG. 8C, once a program is selected, the donor can navigate to the next step. The donor clicks the “NEXT” button to proceed.

Responsive to the donor selecting the program they want to participate in, the donor may or may not be prompted with additional questions. As shown in FIG. 8D, the interface displays a custom question text field where the donor is required to respond to the custom question before proceeding. The donor may input an answer to the custom question. The donor may also be required to check a box authorizing submission of their matching gift request.

As shown in FIG. 8E, if there are additional questions, the donor may not submit the request without inputting an answer to each question. Additionally, the donor must input their response authorizing the submission of the matching gift request. Once the donor has provided the necessary information and checked the authorization box, the donor may click the “SUBMIT” button to proceed.

As shown in FIG. 8F, the successful submission of the matching gift request is confirmed. The interface displays a message, “Yes! Thank you for submitting your matching gift request!” This confirmation may be followed by a customizable message from the corporate vendor platform.

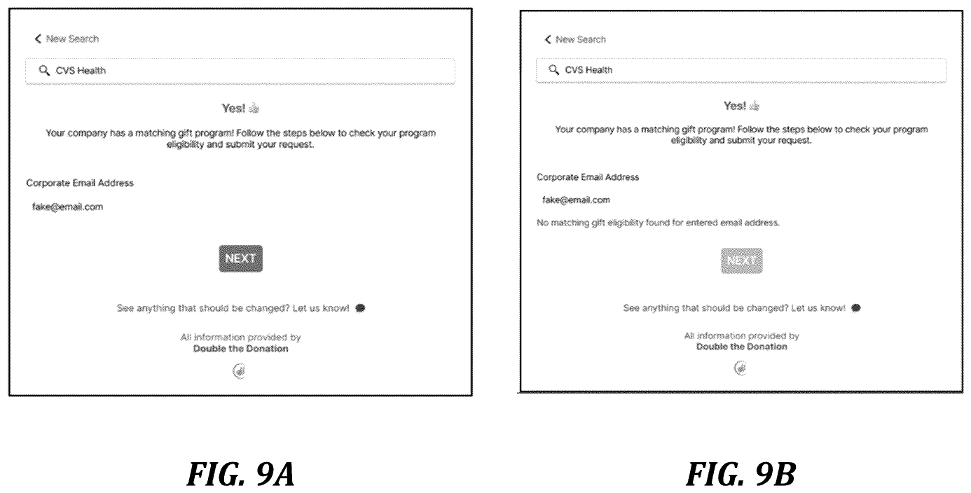

FIGS. 9A and 9B show an example interface for a process flow involved in the auto-submission of a matching gift request. This illustrates a scenario where a donor begins the auto-submission process, but the selected company does not offer a matching gift program to the donor. This may occur because the donor is an ineligible employee, not an employee at all, or for some other reason.

As shown in FIG. 9A, the donor enters their corporate email address to verify their identity. The interface displays a search bar where the donor can search for their company, in this example, “CVS Health.” The interface confirms the presence of a matching gift program with a message, “Yes! Your company has a matching gift program! Follow the steps below to check your program eligibility and submit your request.” That is, the interface shows that the selected company does have a donation matching program.

The donor is prompted to enter their corporate email address in the provided field. After entering the corporate email address (fake@email.com), the donor clicks the “NEXT” button to proceed.

As shown in FIG. 9B, the system attempts to verify the donor's eligibility for the matching gift program using the entered email address. The interface displays a failure message, “No matching gift eligibility found for entered email address.” This indicates that the donor cannot proceed past this point due to the lack of eligibility. The donor is informed that they are not eligible for the matching gift program, and the process is halted.

### V. Hardware Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 300. The computing device 300 may comprise, but not be limited to, the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exascale supercomputer, a mainframe, or a quantum computer;

A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although method 200 has been described to be performed by a computing device 300, it should be understood that, in some embodiments, different operations may be performed by a plurality of the computing devices 300 in operative communication on at least one network.

Embodiments of the present disclosure may comprise a system having a central processing unit (CPU) 320, a bus 330, a memory unit 340, a power supply unit (PSU) 350, and one or more Input/Output (1/0) units. The CPU 320 coupled to the memory unit 340 and the plurality of I/O units 360 via the bus 330, all of which are powered by the PSU 350. It should be understood that, in some embodiments, each disclosed unit may actually be a plurality of such units for redundancy, high availability, and/or performance purposes. The combination of the presently disclosed units is configured to perform the stages of any method disclosed herein.

FIG. 3 is a block diagram of a system including computing device 300. Consistent with an embodiment of the disclosure, the aforementioned CPU 320, the bus 330, the memory unit 340, a PSU 350, and the plurality of I/O units 360 may be implemented in a computing device, such as computing device 300 of FIG. 3. Any suitable combination of hardware, software, or firmware may be used to implement the aforementioned units. For example, the CPU 320, the bus 330, and the memory unit 340 may be implemented with computing device 300 or any of other computing devices 300, in combination with computing device 300. The aforementioned system, device, and components are examples and other systems, devices, and components may comprise the aforementioned CPU 320, the bus 330, and the memory unit 340, consistent with embodiments of the disclosure.

At least one computing device 300 may be embodied as any of the computing elements illustrated in all of the attached figures, including [list the modules and methods]. A computing device 300 does not need to be electronic, nor even have a CPU 320, nor bus 330, nor memory unit 340. The definition of the computing device 300 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 300, especially if the processing is purposeful.

With reference to FIG. 3, a system consistent with an embodiment of the disclosure may include a computing device, such as computing device 300. In some configurations, the computing device 300 may include at least one clock module 310, at least one CPU 320, at least one bus 330, and at least one memory unit 340, at least one PSU 350, and at least one I/O 360 module, wherein I/O module may be comprised of, but not limited to a non-volatile storage sub-module 361, a communication sub-module 362, a sensors sub-module 363, and a peripherals sub-module 364.

In a system consistent with an embodiment of the disclosure, the computing device 300 may include the clock module 310, known to a person having ordinary skill in the art as a clock generator, which produces clock signals. Clock signals may oscillate between a high state and a low state at a controllable rate and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 320, the central component of modern computers, which relies on a clock signal. The clock 310 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 300 may use a “clock multiplier” which multiplies a lower frequency external clock to the appropriate clock rate of the CPU 320. This allows the CPU 320 to operate at a much higher frequency than the rest of the computing device 300, which affords performance gains in situations where the CPU 320 does not need to wait on an external factor (like memory 340 or input/output 360). Some embodiments of the clock 310 may include dynamic frequency change, where the time between clock edges can vary widely from one edge to the next and back again.

In a system consistent with an embodiment of the disclosure, the computing device 300 may include the CPU 320 comprising at least one CPU Core 321. In other embodiments, the CPU 320 may include a plurality of identical CPU cores 321, such as, but not limited to, homogeneous multi-core systems. It is also possible for the plurality of CPU cores 321 to comprise different CPU cores 321, such as, but not limited to, heterogeneous multi-core systems, big.LITTLE systems and some AMD accelerated processing units (APU). The CPU 320 reads and executes program instructions which may be used across many application domains, for example, but not limited to, general purpose computing, embedded computing, network computing, digital signal processing (DSP), and graphics processing (GPU). The CPU 320 may run multiple instructions on separate CPU cores 321 simultaneously. The CPU 320 may be integrated into at least one of a single integrated circuit die, and multiple dies in a single chip package. The single integrated circuit die and/or the multiple dies in a single chip package may contain a plurality of other elements of the computing device 300, for example, but not limited to, the clock 310, the bus 330, the memory 340, and I/O 360.

The CPU 320 may contain cache 322 such as but not limited to a level 1 cache, a level 2 cache, a level 3 cache, or combinations thereof. The cache 322 may or may not be shared amongst a plurality of CPU cores 321. The cache 322 sharing may comprise at least one of message passing and inter-core communication methods used for the at least one CPU Core 321 to communicate with the cache 322. The inter-core communication methods may comprise, but not be limited to, bus, ring, two-dimensional mesh, and crossbar. The aforementioned CPU 320 may employ symmetric multiprocessing (SMP) design.

The one or more CPU cores 321 may comprise soft microprocessor cores on a single field programmable gate array (FPGA), such as semiconductor intellectual property cores (IP Core). The architectures of the one or more CPU cores 321 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 321, for example, but not limited to Instruction-level parallelism (ILP) such as, but not limited to, superscalar pipelining, and Thread-level parallelism (TLP).

Consistent with the embodiments of the present disclosure, the aforementioned computing device 300 may employ a communication system that transfers data between components inside the computing device 300, and/or the plurality of computing devices 300. The aforementioned communication system will be known to a person having ordinary skill in the art as a bus 330. The bus 330 may embody internal and/or external hardware and software components, for example, but not limited to a wire, an optical fiber, various communication protocols, and/or any physical arrangement that provides the same logical function as a parallel electrical bus. The bus 330 may comprise at least one of a parallel bus, wherein the parallel bus carries data words in parallel on multiple wires; and a serial bus, wherein the serial bus carries data in bit-wise serial form. The bus 330 may embody a plurality of topologies, for example, but not limited to, a multidrop/electrical parallel topology, a daisy chain topology, and connected by switched hubs, such as a USB bus. The bus 330 may comprise a plurality of embodiments, for example, but not limited to:
Internal data bus (data bus) 331/Memory bus
Control bus 332
Address bus 333
System Management Bus (SMBus)
Front-Side-Bus (FSB)
External Bus Interface (EBI)
Local bus
Expansion bus
Lightning bus
Controller Area Network (CAN bus)
Camera Link
ExpressCard.
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCle (M-PCle), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 300 may employ hardware integrated circuits that store information for immediate use in the computing device 300, known to persons having ordinary skill in the art as primary storage or memory 340. The memory 340 operates at high speed, distinguishing it from the non-volatile storage sub-module 361, which may be referred to as secondary or tertiary storage, which provides relatively slower-access to information but offers higher storage capacity. The data contained in memory 340, may be transferred to secondary storage via techniques such as, but not limited to, virtual memory and swap. The memory 340 may be associated with addressable semiconductor memory, such as integrated circuits consisting of silicon-based transistors, that may be used as primary storage or for other purposes in the computing device 300. The memory 340 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 341, Static Random-Access Memory (SRAM) 342, CPU Cache memory 325, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 343, Programmable ROM (PROM) 344, Erasable PROM (EPROM) 345, Electrically Erasable PROM (EEPROM) 346 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non- volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 300 may employ a communication system between an information processing system, such as the computing device 300, and the outside world, for example, but not limited to, human, environment, and another computing device 300. The aforementioned communication system may be known to a person having ordinary skill in the art as an Input/Output (I/O) module 360. The I/O module 360 regulates a plurality of inputs and outputs with regard to the computing device 300, wherein the inputs are a plurality of signals and data received by the computing device 300, and the outputs are the plurality of signals and data sent from the computing device 300. The I/O module 360 interfaces with a plurality of hardware, such as, but not limited to, non-volatile storage 361, communication devices 362, sensors 363, and peripherals 364. The plurality of hardware is used by at least one of, but not limited to, humans, the environment, and another computing device 300 to communicate with the present computing device 300. The I/O module 360 may comprise a plurality of forms, for example, but not limited to channel I/O, port mapped I/O, asynchronous I/O, and Direct Memory Access (DMA).

Consistent with the embodiments of the present disclosure, the aforementioned computing device 300 may employ a non-volatile storage sub-module 361, which may be referred to by a person having ordinary skill in the art as one of secondary storage, external memory, tertiary storage, off-line storage, and auxiliary storage. The non-volatile storage sub-module 361 may not be accessed directly by the CPU 320 without using an intermediate area in the memory 340. The non-volatile storage sub-module 361 may not lose data when power is removed and may be orders of magnitude less costly than storage used in memory 340. Further, the non-volatile storage sub-module 361 may have a slower speed and higher latency than in other areas of the computing device 300. The non-volatile storage sub-module 361 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (361) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD±R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 300 may employ a communication sub-module 362 as a subset of the I/O module 360, which may be referred to by a person having ordinary skill in the art as at least one of, but not limited to, a computer network, a data network, and a network. The network may allow computing devices 300 to exchange data using connections, which may also be known to a person having ordinary skill in the art as data links, which may include data links between network nodes. The nodes may comprise networked computer devices 300 that may be configured to originate, route, and/or terminate data. The nodes may be identified by network addresses and may include a plurality of hosts consistent with the embodiments of a computing device 300. Examples of computing devices that may include a communication sub-module 362 include, but are not limited to, personal computers, phones, servers, drones, and networking devices such as, but not limited to, hubs, switches, routers, modems, and firewalls.

Two nodes can be considered networked together when one computing device 300 can exchange information with the other computing device 300, regardless of any direct connection between the two computing devices 300. The communication sub-module 362 supports a plurality of applications and services, such as, but not limited to World Wide Web (WWW), digital video and audio, shared use of application and storage computing devices 300, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 362 may comprise a plurality of size, topology, traffic control mechanisms and organizational intent policies. The communication sub-module 362 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 300 may employ a sensors sub-module 363 as a subset of the I/O 360. The sensors sub-module 363 comprises at least one of the device, module, or subsystem whose purpose is to detect events or changes in its environment and send the information to the computing device 300. Sensors may be sensitive to the property they are configured to measure, may not be sensitive to any property not measured but be encountered in its application, and may not significantly influence the measured property. The sensors sub-module 363 may comprise a plurality of digital devices and analog devices, wherein if an analog device is used, an Analog to Digital (A-to-D) converter must be employed to interface the said device with the computing device 300. The sensors may be subject to a plurality of deviations that limit sensor accuracy. The sensors sub-module 363 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 300 may employ a peripherals sub-module 364 as a subset of the I/O 360. The peripheral sub-module 364 comprises ancillary devices uses to put information into and get information out of the computing device 300. There are 3 categories of devices comprising the peripheral sub-module 364, which exist based on their relationship with the computing device 300, input devices, output devices, and input/output devices. Input devices send at least one of data and instructions to the computing device 300. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 300. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 364:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 300. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 300 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 300. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 362), data storage devices (non-volatile storage 361), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. One or more non-transitory computer readable media comprising instructions which, when executed by one or more hardware processors, causes performance of operations comprising:
receiving an indication of an employee donation to a nonprofit organization from a donation form of an external donation platform;
determining additional information needed for a corporation employing the employee to make a supplemental donation to the nonprofit organization;
causing collection of the additional information from one or more of: the donation form and the non-profit organization;
determining, based at least in part on one or more rules, the indication of the employee donation, and the collected additional information, that the employee donation is eligible for a supplemental corporate donation;
submitting, to a corporate vendor platform associated with the corporation, a request for the supplemental corporate donation, the request comprising at least a portion of the additional information and the indication of the employee donation; and
notifying the nonprofit organization of the submitted supplemental corporate donation.

2. The computer readable media of claim 1, the operations further comprising notifying the nonprofit organization of disbursement of the supplemental corporate donation.

3. The computer readable media of claim 1, the operations further comprising causing storage of data associated with the submitted matching donation.

4. The computer readable media of claim 1, wherein the notification of the employee donation comprises one or more of:
an EIN associated with the non-profit organization,
a donation amount, or
an employee identifier.

5. The computer readable media of claim 1, wherein the one or more rules comprises at least one of:
a minimum donation dollar amount to be matched,
a maximum donation dollar amount to be matched,
one or more employee eligibility criteria, or
a donation match ratio.

6. The computer readable media of claim 5, wherein the additional information comprises one or more of an employee email address, an employee identification number, or an employee job title.

7. The computer readable media of claim 1, wherein the indication of the employee donation to the nonprofit organization is received in real-time.

8. A computer-implemented method for submitting supplemental corporate donation requests, comprising:
receiving, via a computer interface, an indication of an employee donation to a nonprofit organization from a donation form of an external donation platform;
determining additional information needed for a corporation employing the employee to make a supplemental donation to the nonprofit organization;
causing collection of the additional information from one or more of: the electronic donation form and the non-profit organization;
determining, based at least in part on one or more rules, the indication of the employee donation, and the collected additional information, that the employee donation is eligible for a supplemental corporate donation;
submitting, to a corporate vendor platform associated with the corporation, a request for the supplemental corporate donation, the request comprising at least a portion of the additional information and the indication of the employee donation; and
notifying the nonprofit organization of the submitted supplemental corporate donation.

9. The method of claim 8, further comprising notifying the nonprofit organization of disbursement of the supplemental corporate donation.

10. The method of claim 8, further comprising causing storage of data associated with the submitted matching donation.

11. The method of claim 8, wherein the notification of the employee donation comprises one or more of:
an EIN associated with the non-profit organization,
a donation amount, or
an employee identifier.

12. The method of claim 8, wherein the one or more rules comprises at least one of:
a minimum donation dollar amount to be matched,
a maximum donation dollar amount to be matched,
one or more employee eligibility criteria, or
a donation match ratio.

13. The method of claim 12, wherein the additional information comprises one or more of an employee email address, an employee identification number, or an employee job title.

14. The computer readable media of claim 1, wherein the indication of the employee donation to the nonprofit organization is received in real-time.

15. A system comprising:
at least one device including a hardware processor;
the system being configured to perform operations comprising:
receiving an indication of an employee donation to a nonprofit organization from a donation form of an external donation platform;
determining additional information needed for a corporation employing the employee to make a supplemental donation to the nonprofit organization;
causing collection of the additional information from one or more of: the donation form and the non-profit organization;
determining, based at least in part on one or more rules, the indication of the employee donation, and the collected additional information, that the employee donation is eligible for a supplemental corporate donation;
submitting, to a corporate vendor platform associated with the corporation, a request for the supplemental corporate donation, the request comprising at least a portion of the additional information and the indication of the employee donation; and
notifying the nonprofit organization of the submitted supplemental corporate donation.

16. The system of claim 15, the operations further comprising notifying the nonprofit organization of disbursement of the supplemental corporate donation.

17. The system of claim 15, the operations further comprising causing storage of data associated with the submitted matching donation.

18. The system of claim 15, wherein the notification of the employee donation comprises one or more of:
an EIN associated with the non-profit organization,
a donation amount, or
an employee identifier; and
wherein the one or more rules comprises at least one of:
a minimum donation dollar amount to be matched,
a maximum donation dollar amount to be matched,
one or more employee eligibility criteria, or
a donation match ratio.

19. The system of claim 18, wherein the additional information comprises one or more of an employee email address, an employee identification number, or an employee job title.

20. The system of claim 15, wherein the indication of the employee donation to the nonprofit organization is received in real-time.
